(19) United States
(12) Patent Application Publication
(10) Pub. No.: US 2008/0237199 A1
(43) Pub. Date: Oct. 2, 2008

(54) SPOT WELDING ELECTRODE TIP WEAR VERIFICATION METHOD

(75) Inventor: Windham Phillips, Lincoln, AL (US)

Correspondence Address: STANDLEY LAW GROUP LLP, 495 METRO PLACE SOUTH, SUITE 210, DUBLIN, OH, 43017, US

(73) Assignee: Honda Motor Co., Ltd., Tokyo (JP)

(21) Appl. No.: 11/693,770

(22) Filed: Mar. 30, 2007

(51) Int. Cl. B23K 11/36; B23K 11/11

(52) U.S. Cl. 219/91.2

(57) ABSTRACT

A method for ensuring that a spot weld electrode tip dressing operation is performed properly at each occurrence thereof. The method of the present invention takes advantage of an electrode wear compensation routine inherent to most spot weld robots. The method uses measurements of total tip wear as determined by the electrode wear compensation routine to calculate a difference in electrode wear between selected numbers of successive tip dressing operations. This value is then used to perform a comparison with the stored average tip wear per tip dress value, or a tip wear value derive therefrom, to conclude whether the tip dressing operation is operating properly.

### BACKGROUND OF THE INVENTIVE FIELD

The present invention is directed to a method for monitoring the wear of a spot weld electrode. More particularly, the present invention is directed to a method for monitoring the amount of wear imparted to a spot weld electrode during a tip dressing operation and for verifying that the tip dressing operation is being properly performed.

Spot welding is a commonly employed resistance welding technique used to join metallic work pieces. Spot welding operates by passing electric current through the work pieces to be joined. This causes a localized heating of the work pieces that is sufficient to produce a molten weld pool therebetween. Upon cooling, the weld pool forms a weld nugget that joins the work pieces.

As it is desirable to conduct the electric current as efficiently as possible, conducting electrodes are employed to contact the work pieces at the welding location. Although various conductive metals may technically be used, copper is most commonly utilized in the manufacture of weld electrodes. The use of copper helps to facilitate the generation of sufficient heat to produce the localized melting of the work pieces to be joined. Copper also exhibits a high thermal conductivity in comparison to most other metals. Consequently, the use of copper weld electrodes helps to ensure that the heat produced by the electric current is concentrated at the welding spot as opposed to migrating to other components of an associated welding device.

In addition to the passage of sufficient electric current, spot welding also requires that the weld electrodes be forcibly pressed against the work pieces during the welding process. Pressing of the weld electrodes against the work pieces acts to increase the electrical resistance therebetween. As such, the amount of force exerted by the electrodes can be adjusted to create substantially immediate heat at the interface between the work pieces.

While copper is an excellent material for efficiently transferring electrically-produced heat to work pieces to be joined, it is also a soft material. Consequently, copper weld electrodes are prone to wear and/or damage. For example, weld electrodes wear down and/or become deformed during use as a result of heat generated by the welding process, and also due to the force they are required to exert against the work pieces upon which they operate. Consequently, in order to keep a weld electrode in satisfactory welding condition, the weld electrode is typically subjected to a periodic cutting or shaping process commonly referred to as “tip dressing”.

Tip dressing is generally accomplished by employing some type of grinding or cutting device to which the tip of a weld electrode is contacted. Such a tip dressing device operates to return the weld electrode to its proper shape and size. In doing so, the tip dressing device removes a small amount of the electrode material at each tip dressing operation. Eventually, electrode replacement is required due to the cumulative effect of tip dressing.

In order for a weld electrode to produce an acceptable spot weld, it must be of proper shape and size. For example, if the tip face of the weld electrode has a larger than normal diameter such as might occur as a result of mushrooming caused by the pressing force of the electrode against a work piece, and insufficient weld may be produced. This is caused by an increase in the surface area of the weld electrode tip face, which subsequently allows electric current to pass through a correspondingly larger surface area of the work pieces to be welded—thereby reducing the amount of heat generated in the work pieces.

As long as the tip dressing device used to reform a weld electrode is functioning properly, the desired size and shape of the weld electrode can be maintained. However, if the tip dressing device is not operating properly, defective welds may be produced. For example, depending on the particular design of the tip dressing device, tip dressing problems may occur as a result of a dull tip dressing blade, a clogged tip dressing blade assembly, or a tip dressing device motor failure. Obviously, other problems may occur with tip dressing devices of dissimilar design, but the result will likely be the same—an improperly dressed weld electrode.

Consequently, it can be understood that a monitoring of the tip dressing process is desirable. To this end, various methods of tip dressing process monitoring have been proposed. These methods include, for example, the use of various sensors for viewing and evaluating a dressed weld electrode, and monitoring motor drain and/or other conditions related to a tip dressing device. However, a more simplistic, efficient and reliable method of evaluating a tip dressing process is needed. The weld electrode tip wear verification method of the present invention satisfies this need.

### SUMMARY OF THE GENERAL INVENTIVE CONCEPT

The weld electrode tip wear verification method (tip wear verification method) of the present invention can be used to determine if an individual tip dressing operation, or some selected number of tip dressing operations, have been performed properly. That is, the tip wear verification method of the present invention is able to determine if an expected amount of electrode material has been removed during the tip dressing operation.

The tip wear verification method of the present invention modifies a “tip sense” or similar electrode wear compensation program inherent to most spot welding robots (or installable thereto). Such programs are typically used to determine a new weld electrode “zero position” after tip dressing thereof. This is generally accomplished by measuring the total amount of wear experienced by the electrode and adjusting its previous zero position accordingly. This allows the weld electrode to continue to be properly contacted to its respective work piece during the welding process, despite the material loss it experiences due to tip dressing.

Before employing the tip wear verification method of the present invention to monitor tip dressing operations on an assembly line or another manufacturing setting, data relating to a particular tip dressing device that will be used is preferably collected. Primarily, the total amount of electrode material removed by the tip dressing device over some number of known tip dressing operations is preferably measured—and an average amount of tip wear per tip dress is calculated therefrom. As is described in more detail below, this information can then be subsequently used to determine if proper tip dressing is being performed during actual welding operations. Thus, improper tip dressing can be identified.

### BRIEF DESCRIPTION OF THE DRAWINGS

In addition to the features mentioned above, other aspects of the present invention will be readily apparent from the following descriptions of the drawings and exemplary embodiments, wherein like reference numerals across the several views refer to identical or equivalent features, and wherein:

FIG. 1a shows the proper shape of a generic exemplary weld electrode;

FIG. 1b illustrates how the weld electrode of FIG. 1a can be deformed by the welding process;

FIG. 1c depicts the weld electrode of FIG. 1b after undergoing tip dressing;

FIG. 2 is a graph illustrating the collection of electrode wear data with respect to a particular tip dressing device; and

FIG. 3 is a schematic diagram that generally represents the operation of the tip wear verification method of the present invention.

### DETAILED DESCRIPTION OF EXEMPLARY EMBODIMENT(S)

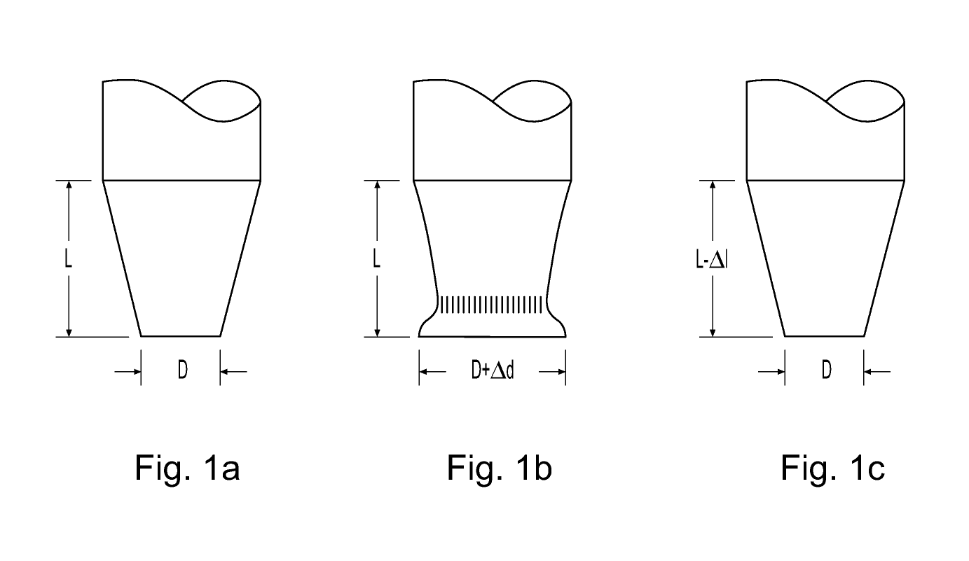

An exemplary spot weld electrode 5 is illustrated in FIG. 1a. in an unused condition. As shown, a tip portion 10 of the weld electrode 5 is substantially frustoconical in shape, with a length L and a diameter D. The weld electrode 5 would be used in conjunction with a second, corresponding weld electrode, to spot weld sheets of material that would be placed therebetween.

The spot weld electrode 5 is depicted in a post-welding condition in FIG. 1b. It can be seen that the previously frustoconical shape of the weld electrode 5 has been deformed by the welding process. More specifically, the previous diameter D of the tip face 15 has been increased (to D+Δd) by a mushrooming of the weld electrode 5. Further, the previous length L of the weld electrode 5 may be slightly reduced. As such, the weld electrode 5 must be subjected to a tip dressing operation.

The weld electrode 5 is shown after tip dressing in FIG. 1c. As can be seen, the tip face 15 has been returned to its correct diameter and the frustoconical shape of the weld electrode has been restored. However, because the tip dressing operation removes an amount of material from the weld electrode, the overall length of the tip portion 10 has been reduced (to L−Δl). The tip wear verification method of the present invention operates by evaluating this change in length Δl per tip dress operation.

As mentioned above, the tip wear verification method of the present invention takes advantage of a “tip sense” or similar electrode wear compensation routine inherent to most spot welding robots. Because the size of a weld electrode is known to change as a result of tip dressing, and because the location of the weld electrode tip face must be known in order for the robot to properly locate the weld electrode to a work piece to be welded, spot welding robots are commonly provided with such routines or programs. A tip sense or similar program typically operates by moving the weld electrode to a detectable stopping position, such as against its corresponding other electrode or against a reference plate. The position of the electrode tip face can then be determined by reading a corresponding position value associated with the robot's encoder(s). The robot can then use this encoder value to determine a new zero position with respect to the weld electrode. That is, the robot calculates an offset to compensate for the amount of material removed from the weld electrode by the tip dressing operation.

Other tip sense or similar electrode wear compensation routines may operate somewhat differently. However, as long as the robot is able to account for the material removed from a weld electrode by tip dressing, it can be used in conjunction with the tip wear verification method of the present invention. Therefore, it is to be understood that the method of the present invention is not limited to use with any particular spot welding robot or any particular electrode wear compensation routine.

Each spot welding robot of a spot welding process is typically associated with its own tip dressing device. Alternatively, more than one spot welding robot may share the same tip dressing device. As such, tip dressing data collected with respect to a particular tip dressing device can be used by any robot serviced thereby.

To permit use of the tip wear verification method of the present invention, it is first ensured that a tip dressing device of interest is working properly. Subsequently, the tip dressing device is used to tip dress a weld electrode some desired number of times. The total amount of material removed from the weld electrode during this process is measured. Measurements may also be taken at shorter intervals, such that the amount of material removed from the weld electrode at less than the total number of monitored tip dressing cycles is also known. Doing so can help to show whether the amount of material removed from the weld electrode by the tip dressing process is consistent as the total amount of electrode wear increases.

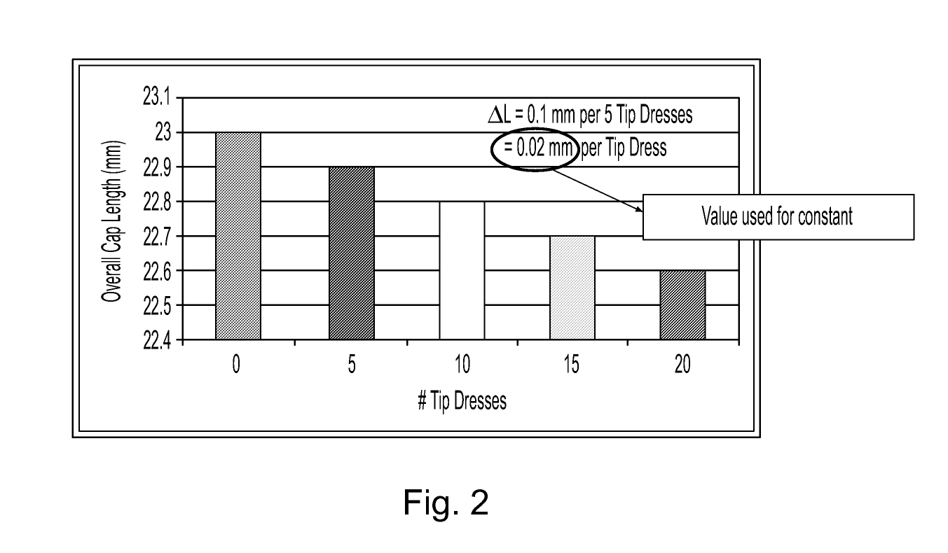

As shown in FIG. 2, once this data is collected, the average amount of electrode wear per tip dress can be determined. This value of average electrode wear is associated with a particular tip dressing device evaluated. While it is contemplated that this average value may be used with respect to other similar tip dressing devices, it is preferred that each separate tip dressing device be evaluated separately, and an average wear per tip dress value be determined therefor. As such, the average wear per tip dress value used may also be different for different spot welding robots.

With an average wear per tip dress value determined, the electrode wear compensation routine of an associated spot welding robot can be modified to monitor each tip dressing operation, or some selected number of tip dressing operations, and evaluate whether the tip dressing operation is being acceptably performed. Alternatively, a PLC or other processing device can be provided with a program that works in conjunction with the electrode wear compensation routine of a spot welding robot to effectuate monitoring and evaluation of a tip dressing operation. For example, such an external program may receive data from and/or transfer data to the robot's electrode wear compensation routine.

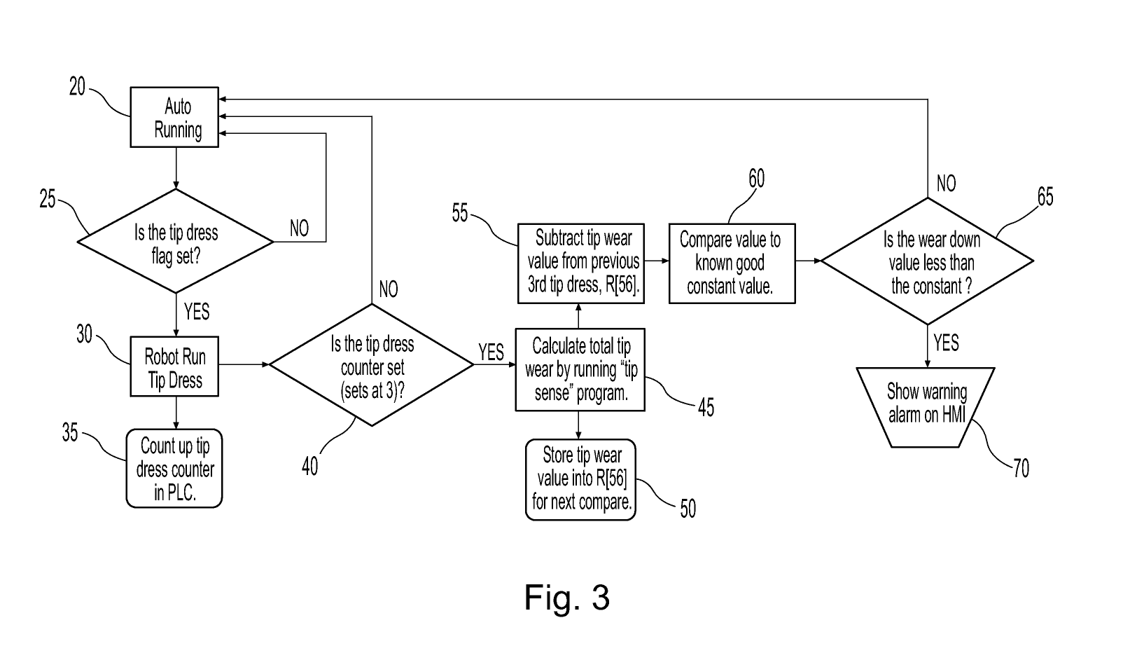

An exemplary tip wear verification process is illustrated by the schematic diagram of FIG. 3. This particular tip wear verification process is accomplished by adding a number of logic statements to the electrode wear compensation routine of an associated spot welding robot. The modified electrode wear compensation routine and/or other robot software may also interact with a PLC or another external processor to accomplish tip wear verification according to the present invention.

As mentioned previously, the specific electrode wear compensation routine installed to a given robot may vary. For example, the robot may be programmed to bring together the weld electrodes at some given force. As such, removal of electrode material during tip dressing will subsequently cause the robot to move the associated gun arms a greater distance in order to create the requisite contact between the weld electrodes. This change in distance can be measure by the robot's encoder(s) and converted to a total wear value for the weld electrodes. Other electrode wear compensation methods are also possible, such as contacting the electrodes against a reference plate, etc.

A normal electrode wear compensation routine generally does nothing in response to individual electrode wear measurements. Rather, no action or response is generally undertaken until the total amount of wear exceeds some predetermined value—at which point a required changing of the electrodes may be indicated. Thus, typical wear compensation programs are not useable to monitor and determine if a tip dressing operation is being performed correctly—especially over a short period of time (e.g., each tip dress, every three tip dresses, etc.). As can be understood from the following description, however, a modified electrode wear compensation routine of the present invention permits such monitoring and evaluation.

As shown in the process schematically depicted by FIG. 3, the spot welding robot is running in automatic mode 20—under the guidance of a spot welding control program. When a tip dress is required (such as after some predetermined number of welding cycles), a tip dress flag 25 is set in the robot control program (or in a related but external program). The tip dress flag 25 tells the robot to perform a tip dressing operation 30 prior to starting the next welding cycle, whereby the robot places the weld electrode into proper contact with an associated tip dressing device.

Setting of the tip dress flag 25 can be caused to occur at various intervals. Generally, setting of the tip dress flag 25 is based on the total number of welding cycles that have been performed by the weld electrode since it was last tip dressed. A welding cycle may comprise a single weld or a multitude of welds. For example, the robot program can set the tip dress flag 25 after every welding cycle or after some other number of welding cycles. In this particular example, the tip dress flag 25 is set after every third welding cycle and therefore, tip dressing will be performed at that interval. The modified electrode wear compensation routine runs after every tip dressing operation.

A tip dress counter 35 is also used. The tip dress counter 35 is used to keep track of the number of tip dressing operations that have been performed on the weld electrode. The tip dress counter 35 is also operative to specify the number of tip dressing operations that must be performed before the robot compares and evaluates the amount of tip wear measured by the modified electrode wear compensation routine.

More specifically, upon completion of a tip dressing operation 30, the robot control program encounters a decision point 40 regarding whether to run the comparison and evaluation portion of the modified electrode wear compensation routine or whether to simply determine the total amount of tip wear and to adjust the zero position of the weld electrode(s) accordingly.

The current value of the tip dress counter 35 determines what action the robot takes. That is, if the tip dress counter 35 has not yet reached some predetermined set value (in this case three), running of the modified electrode wear compensation routine 45 simply results in a determination of total tip wear and a modification the weld electrode(s) zero point, as described above. However, if the value of the tip dress counter 35 has reached the set value, the modified electrode wear compensation routine 45 functions to evaluate the tip dressing operation as described below.

Running of the modified electrode wear compensation routine 45 results in storing of the detected total amount of tip wear 50 (in register 56 in this example). The stored amount of total tip wear is used as a reference point for subsequent tip dressing operation comparisons. A default tip wear (no tip wear) value may be placed in register 56 (or some other desired storage register) prior to operation of a new weld electrode, so that the modified electrode wear compensation routine has comparison data for use during the initial tip dressing operation evaluation. Alternatively, only data storage (without a comparison) may be performed upon the initial running of the modified electrode wear compensation routine.

As mentioned above, the tip dress counter 35 determines when the robot runs the modified electrode wear compensation routine to evaluate the tip dressing operation. For example, if the tip dress counter 35 sets at one, then the robot will run the modified electrode wear compensation routine after every tip dressing operation. Consequently, the total tip wear detected after every tip dressing operation will be stored, and the difference between the currently detected amount of total tip wear and the stored tip wear value associated with the immediately preceding tip dressing operation will be compared to evaluate the tip dressing operation. The stored tip wear value will also be subsequently updated with the currently detected total tip wear value. If the tip dress counter is programmed to set at another number, for example, three, then the modified electrode wear compensation routine will only perform an evaluation every three tip dressing operations. It has been discovered that setting the tip dress counter 35 to a number greater than one (e.g., three) can help to avoid false tip dressing operation evaluations due to the presence of shavings, etc., being inadvertently present on an electrode during running of the modified electrode wear compensation routine. Therefore, this is the case exemplified by the diagram FIG. 3, and described in more detail below.

With the tip dress counter 35 programmed to set at three, the modified electrode wear compensation routine evaluates every third tip dressing operation. During interim tip dressing operations, the modified electrode wear compensation routine simply acts to compensate for electrode material removal and provide a new electrode zero position. The value of the total amount of tip wear may also be stored/updated after every tip dressing operation or only after some selected number of tip dressing operations. As shown in this example, the value of the total amount of tip wear is stored/updated only after every third tip dressing operation 50.

When the tip dress counter 35 reaches three, the modified electrode wear compensation routine functions to re-zero the weld electrode(s) and also subtracts the previously stored total tip wear value from the newly determined total tip wear value to obtain a difference therebetween 55. This difference is the amount of tip wear produced by the three immediately preceding tip dress operations.

The modified electrode wear compensation routine of the present invention then compares the calculated difference in tip wear values to a stored or calculated average tip wear value derived using the average wear per trip dress value that has been predetermined and associated with the particular tip dressing device (as described above) 60. For example, when, as here, the tip dress counter is set to three, the modified electrode wear compensation routine of the present invention compares the calculated difference in tip wear values to a calculated (expected) average tip wear value for three tip dressing operations. The calculated average tip wear value for three tip dressing operations is obtained by simply multiplying the stored average wear per tip dress value by three. Alternatively, if the tip dress counter is set to one, for example, the modified electrode wear compensation routine of the present invention can compare the calculated difference in tip wear values associated with successive tip dressing operations directly to the stored average wear per trip dress value. Thus, it can be understood that the modified electrode wear compensation routine can operate with the tip dress counter set to virtually any number.

If the determined or calculated amount of tip wear per selected number of tip dressing operations is equal or, typically, within some defined acceptable range of the predetermined or calculated amount of tip wear, the tip dressing device is deemed to be operating properly. If the detected tip wear per selected number of tip dressing operations differs from the predetermined or calculated amount of tip wear, or falls outside an acceptable range of predetermined or calculated tip wear 65, a problem with the tip dressing device or some other aspect of the tip dressing operation is indicated 70.

Depending on the particular application, an acceptable deviation range may include some value only lesser than, only greater than, or both lesser and greater than the expected amount of tip wear. As shown in FIG. 3, only insufficient electrode material removal may be considered as an indicator of a tip dressing problem. That is, the tip dressing operation is deemed to be working properly in FIG. 3 when if it produces as much or more than the average wear per trip dress. Obviously, the specifics of the comparison and the conclusion drawn thereby can be modified by the user as desired.

If no tip dressing problem is indicated by the comparison of tip wear values, the robot returns to the welding operation. If a tip dressing problem is indicated, various actions may be initiated. For example, and as shown in FIG. 3, a warning alarm of some sort may be indicated to an operator. Of course, it is also possible to automatically cause or prohibit some related activity as a result of such an indicator. It is also possible to employ a counter or other technique whereby no alarm is triggered and/or no action is taken until some predetermined number of unacceptable tip dressing operations are indicated—whether such operations occur sequentially or otherwise.

Thus, a tip wear verification method of the present invention allows for the evaluation of electrode tip wear per trip dressing operation. Consequently, a tip dressing problem can be identified and remedied before a large number of unacceptable welds are produced.

As can be understood from the foregoing description, variations in such a verification method are possible while remaining within the scope of the present invention. For example, it is to be realized that a tip wear verification method of the present invention can be used with any robot inherently or otherwise capable of measuring the amount of electrode material removed during tip dressing. The calculations required to effectuate an evaluation of tip wear per tip dress may be carried out by a spot welding robot, by a PLC or other external processor, or by some combination thereof. For example, an external processor and program may receive and/or send data from/to the electrode wear compensation routine of a spot welding robot, etc.

Therefore, it can also be understood that while certain embodiments of the present invention are described in detail above for purposes of illustration, the scope of the invention is not to be considered limited by such disclosure, and modifications are possible without departing from the spirit of the invention as evidenced by the following claims:

What is claimed is:

1. A method of monitoring a spot weld electrode tip dressing device, comprising:
establishing an average amount of weld electrode tip wear produced by a properly operating tip dress device of interest per tip dressing operation;
using an electrode wear compensation routine of a spot welding robot to determine the total amount of wear imparted to its weld electrode by said tip dressing device;
using the difference between the total amount of electrode tip wear present after a most recent tip dressing operation and the total amount of electrode tip wear present after an immediately preceding tip dressing operation to calculate an actual average amount of weld electrode tip wear per tip dressing operation; and
comparing the actual amount of weld electrode tip wear per tip dressing operation to the previously established average amount of weld electrode tip wear per tip dressing operation to determine whether said tip dressing device is operating properly.

2. The method of claim 1, wherein said calculation and comparison is performed by said spot welding robot.

3. The method of claim 1, wherein said calculation and comparison is performed by a processor external to said spot welding robot.

4. The method of claim 1, wherein said calculation and comparison is performed by a combination of said spot welding robot and a processor external to said spot welding robot.

5. The method of claim 1, further comprising a counter for keeping track of the total number of tip dressing operations performed on said weld electrode.

6. The method of claim 1, wherein said tip dressing device is deemed to be operating properly when the actual amount of weld electrode tip wear per tip dressing operation has a value that falls within some predefined range of the established average amount of weld electrode tip wear per tip dressing operation.

7. The method of claim 6, wherein said predefined range includes values that are both less than and greater than the value of said established average amount of weld electrode tip wear per tip dressing operation.

8. The method of claim 6, wherein said predefined range includes only values that are equal to or greater than the value of said established average amount of weld electrode tip wear per tip dressing operation.

9. The method of claim 1, further comprising alerting an operator when a tip dressing device is deemed to be operating improperly.

10. The method of claim 1, further comprising sending a signal to a downstream manufacturing device or process when a tip dressing device is deemed to be operating improperly.

11. A method of evaluating a spot weld electrode tip dressing operation, comprising:
establishing and storing an average amount of material removed from a weld electrode per tip dressing operation by a properly operating tip dressing device of interest;
associating said tip dressing device with a spot welding robot;
using an electrode wear compensation routine of said spot welding robot to determine the total amount of material that has been removed from its associated weld electrode by said tip dressing device after a selected number of tip dressing operations have been performed thereon;
calculating the difference between the total amount of material removed from said weld electrode as of a selected number of most recent tip dressing operations and the total amount of material removed from said weld electrode as of said same selected number of immediately preceding tip dressing operations; and
comparing the difference in the total material removed from said weld electrode by said selected number of most recent tip dressing operations to a calculated average amount of material that should be removed from a weld electrode per said selected number of tip dressing operations to determine whether the tip dressing operation is operating properly.

12. The method of claim 11, wherein said calculation and comparison is performed by said spot welding robot.

13. The method of claim 11, wherein said calculation and comparison is performed by a processor external to said spot welding robot.

14. The method of claim 11, wherein said calculation and comparison is performed by a combination of said spot welding robot and a processor external to said spot welding robot.

15. The method of claim 11, further comprising a counter for keeping track of the total number of tip dressing operations performed on said weld electrode.

16. The method of claim 11, wherein a tip dressing operation is deemed to be operating properly when the calculated difference in the total amount of material removed from said weld electrode has a value that falls within some predefined range of the calculated average amount of material that should be removed from a weld electrode per said selected number of tip dressing operations.

17. The method of claim 11, further comprising alerting an operator when a tip dressing operation is deemed to have been unacceptably completed.

18. The method of claim 11, further comprising sending a signal to a downstream manufacturing device or process when a tip dressing operation is deemed to have been unacceptably completed.

19. A method of evaluating a spot weld electrode tip dressing operation, comprising:
ascertaining an average change in length of a weld electrode per tip dressing operation by a properly operating tip dressing device of interest;
storing said ascertained average change in length of said weld electrode per tip dressing operation as a constant value;
associating said tip dressing device with a spot welding robot;
after each tip dressing operation performed thereon by said tip dressing device, using an electrode wear compensation routine of said spot welding robot to determine the total change in length of its associated weld electrode;
calculating the difference between the total change in length of said weld electrode caused by a selected number of most recent tip dressing operations and the total change in length of said weld electrode as of said same selected number of immediately preceding tip dressing operations; and
comparing the calculated difference in the total change in length of said weld electrode as a result of said selected number of most recent tip dressing operations to a calculated average change in length of said weld electrode per said selected number of tip dressing operations to determine whether said tip dressing operation is operating properly.

20. The method of claim 19, wherein said calculation and comparison is performed by said spot welding robot.

21. The method of claim 19, wherein said calculation and comparison is performed by a processor external to said spot welding robot.

22. The method of claim 19, wherein said calculation and comparison is performed by a combination of said spot welding robot and a processor external to said spot welding robot.

23. The method of claim 19, further comprising a counter for keeping track of the total number of tip dressing operations performed on said weld electrode.

24. The method of claim 19, wherein the tip dressing operation is deemed to be operating properly when the calculated difference in the total change in length of said weld electrode has a value that falls within some predefined range of said calculated average change in length of said weld electrode per said selected number of tip dressing operations.

25. The method of claim 19, further comprising alerting an operator when a tip dressing operation is deemed to have been unacceptably completed.

26. The method of claim 19, further comprising sending a signal to a downstream manufacturing device or process when a tip dressing operation is deemed to have been unacceptably completed.
